(19) United States
(12) Patent Application Publication
(10) Pub. No.: US 2023/0323095 A1
(43) Pub. Date: Oct. 12, 2023

(54) A BIODEGRADABLE COMPOSITE MATERIAL

(71) Applicant: SEARO LABS LTD, Cambridge (GB)

(72) Inventor: Ayca DUNDAR FIELD, Cambridge (GB)

(21) Appl. No.: 18/023,307

(22) PCT Filed: Aug. 26, 2021
(86) PCT No.: PCT/GB2021/052216

§ 371 Date: Feb. 24, 2023

(30) Foreign Application Priority Data
Aug. 26, 2020 (GB) 2013316.1

(51) Int. Cl. C08L 5/00

(52) U.S. Cl. CPC C08L 5/00

(57) ABSTRACT

This invention relates to a biodegradable composite material, wherein the composite material comprises a seaweed extract in an amount of 30-70 % by weight, a biodegradable filler in an amount of 20-60 % by weight and water in an amount of 1-20 % by weight of the total weight of the composite. The invention also relates to: products, including packaging material and crockery formed from the composite material, a method of dissolving, composting and biodegrading the composite material or the products, a method of producing the composite material and the products, and a method of re-working the composite material.

### TECHNICAL FIELD

This invention relates to a biodegradable composite material. The invention also relates to: products, including packaging material and crockery formed from the composite material, a method of dissolving, composting and biodegrading the composite material or the products, a method of producing the composite material and the products, and a method of re-working the composite material.

### BACKGROUND

Conventional lightweight, thermally-insulating products are made of either petroleum-based plastics, such as expanded polystyrene, or plant-based bioplastic equivalents. Such materials are lightweight, durable, have good thermal insulation properties and have high tensile strength. Furthermore, such materials can have mouldability characteristics which are suitable for mass manufacturing. This makes them very desirable, for example, for use as packaging materials and cups.

There is a general desire to move away from plastics derived from petroleum. This is largely due to the high environmental impact of such products both during production, and in the disposal stream after use. Furthermore, non-biodegradable bioplastics that are not subject to industrial composting, or other specific waste treatment processes, tend to disintegrate in nature leading to particulate plastic material (micro- or nano- plastics) that can remain in the environment, having a detrimental impact, for hundreds of years.

Left unchecked, plastic pollution is anticipated to increase fourfold by 2050, by which time it is anticipated that there will be more plastic in the oceans by weight than fish. One of the key contributors to this growing problem is single-use plastics used as structural stock keeping units [SKUs] (those that can be formed into containers that are rigid and load-bearing), such as used in packaging and disposable cups.

In view of these issues there has been a recent trend towards use of biodegradable plastics. However, traditional biodegradable plastics, and those based on plant-derived materials, so-called biobased materials, tend to break down slowly, often over a time period that is much longer than the useful lifespan of the product. As a result, even these so-called biodegradable materials, that are dubbed environmentally friendly, require complex waste management systems, or if discarded inappropriately, can remain in the environment for considerable time, potentially causing significant ecological harm for tens of years and even hundreds of years.

As an alternative to foam plastics, composite materials are known for preparing thermally-insulating materials. Composite materials offer many advantages over single component products, mainly in their ability to tune and adapt the properties base on the selection and the proportions of the constituents. However, composite materials are often difficult to recycle as each component typically requires a different waste disposal stream and separating these components can often present a challenge.

Some composite materials line or coat thermally insulating materials such as corrugated cardboard, an example of this is disposable coffee cups. Other composite materials use filler particulate materials, and a binder. Composite materials formed of biodegradable fillers and/or natural organic fillers, such as cork, tealeaves, coffee granules, sawdust, paper, hemp fibre, hay, straw, dried and granulated food waste etc. and a suitable binder or adhesive are known, for example, agglomerated cork is the name given to cork granules, optionally mixed with granules of other materials, held together by a binder to form a sheet or block material. However, the binder in these composites are often glue-based or other petroleum-derived which suffers the same environmental drawbacks as other petroleum-derived products.

The term ‘biodegradable composites’ comprises a wide range of at least two-phase hybrid materials in which either fillers or matrix or both must be chosen from biodegradable sources. However, encapsulating a biodegradable filler in a non-biodegradable binder would not necessarily result in a biodegradable material. To ensure rapid mechanical and/or chemical breakdown of the material, the binder that holds the filler together must break down quickly to permit the inherent biodegradability of the filler material.

Cork, as an example of a biodegradable filler, is a highly sustainable natural material that comes from the outer bark of the cork oak tree (sp: Quercus suber) that is renewable resource and harvested from the living tree at regular intervals, not sooner than every 5 years. Cork has unique properties such as lightness and buoyancy, thermal insulation, resistance to high temperatures and is hypoallergenic and impermeable to liquids and gases.

Cork is used in several industries such as consumer goods, automotive, power industry, construction, flooring, panel and composites, etc. Cork may be used in its natural state, however, 99% of cork products are made by cork composites; combining the cork granules with petroleum-based plastic binder such as ABS, PVC, PE, thermoplastic elastomers like rubber or bioplastics such as PLA. However, these composite materials do not biodegrade naturally and causes environmental hazards that last for centuries.

Agglomerated cork using cork granule filler and polyurethane glues is known, see for example U.S. Pat. No. 5.317,047. Despite cork being a natural wood product and inherently biodegradable, the composite material is not due to the non-biodegradability of the binder.

Cork composites that make use of a binder that comprises a biodegradable material have been described. WO2016020361 describes the use of biobased plastics as a binder. However, it is stated that the binder must only meet the criteria as set out in ASTM 6400 which requires that the material is aerobically compostable in an industrial and municipal compositing facilities. The use of the composite material is described is for corks for bottles and therefore it must be implied that the material does not biodegrade readily or rapidly on contact with water or moisture.

Sawdust, as another example of a biodegradable filler, is a clean, free-flowing, cheap and readily available as a waste by-product of woodworking operations such as planning, routing drilling, sanding and sawing. Using sawdust provides a new use for recycled wood fibers and consequently reduces waste in landfills. Sawdust has been used as a filler with different petroleum-derived polymers such as polyethylene [Horta et al., Procedia Manufacturing, 12, 2017, pp. 221-229 and Kusuktham, Siliconidia 11(4), 2019, pp. 1997-2013], polystyrene [Latthe et al., Mater. Chem. Phys. 2020, pp.122634; Nasution et al., J. Eng., 15(2), 2019, pp. 17-29; Bruscato et al., J. Clean Prod.., 234, 2019, pp 225-232], polypropylene [Femanda et al., Polym. Test., 19, 2000, pp. 625-629], natural rubber [Homkhiew et al., Int. J. Polym. Sci., 2018], ethylene-propylene-polymer rubber [Craciun et al., Polymers, 12(1), 2020, 215]. Sawdust has not previously been used a biodegradable material in a hyper biodegradable composite, or with a seaweed-based binder.

Tea leaves and coffee grounds as by-products of the hospitality industry are further examples of biodegradable fillers that have the combined advantages of biodegradability once the composite begins to break down, and also makes use of what would otherwise be a waste product ending up in landfill.

Hemp, paper, hay and straw are further well-known fillers used in other composites.

There remains a need to replace thermally insulating plastic and bioplastic in products with environmentally benign materials that quickly and fully biodegrade in the environment or in waste streams without, or with only minimal, harm to the environment or ecosystems. Such a replacement may suitably make use of a biodegradable binder for a biodegradable thermally insulating filler material, such as cork. Suitably, the time for biodegradation of the thermally insulating material would be better matched to the timescale of use (specifically, single-use), whilst still providing at least one of the desirable material properties of conventional thermally insulating plastics mentioned above.

### SUMMARY OF INVENTION

In a first aspect, the invention provides a composite material comprising a seaweed extract in an amount of 30-70 % by weight, a biodegradable filler in an amount of 20-60 % by weight and water in an amount of 1-20 % by weight, of the total weight of the composite. Suitably, the seaweed extract in present an amount of 40-60 % by weight, a biodegradable filler in an amount of 30-50 % by weight and water in an amount of 2-15 % by weight.

In embodiments, the composite consists essentially of the seaweed extract the biodegradable filler and water. Suitably, the composite consists of the seaweed extract the biodegradable filler and water. Suitably, the weight percentages of the seaweed extract the biodegradable filler and water total 100 % by weight of the total weight of the composite.

In embodiments, the seaweed extract is selected from the group consisting of: a carrageenan; agar; alginate; and a mixture thereof. Suitably, the seaweed extract is a carrageenan. Suitably, the carrageenan is carrageenan kappa.

In embodiments, the composite lacks one or more of the group consisting of: a starch; carrageenan iota; agar; alginate; and chitosan.

In embodiments, the biodegradable filler is selected from the group consisting of: cork, tealeaves, coffee granules, sawdust, paper, hemp fibre, hay, straw, dried and granulated food waste, dried and granulated plant seed, dried and granulated fruit and vegetable peel or skin and mixtures thereof. Suitably, the biodegradable filler is cork.

In embodiments, the composite further comprises one or more additives. Suitably, the one or more additives are present in no greater than 40 % by weight of the total weight of the composite. Suitably, the one or more additives are selected from the group consisting of: salts such as sea salt, table salt, sodium chloride, potassium chloride; and glycerol.

In embodiments, the composite is fully biodegradable. Suitably, the seaweed-extract of the composite:
a) fully biodegrades in less than six months in an external, non-industrial environment;
b) fully biodegrades in an aerobic and/or anaerobic atmosphere; and/or
c) is fully compostable in less than six months in a domestic compost heap
d) fully biodegrades in ocean in less than 6 months.

In embodiments, the composite is mouldable.

In a second aspect, the invention provides a product formed from the composite material of the first aspect. Suitably, the product has a shape selected from the group consisting of: a plate; planar sheet; a regular sphere; an irregular sphere; a regular spheroid; an irregular spheroid; a regular cube; an irregular cube; a regular cuboid; an irregular cuboid; a regular ellipsoid; an irregular ellipsoid; a regular cylinder; an irregular cylinder; a regular cone; an irregular cone; a regular prism; an irregular prism; a regular pyramid; an irregular pyramid; a shell, a clam, or a shape with an internal void or hollow, and any combination thereof.

In a third aspect, the invention provides a method of producing the composite material of the first aspect, the method comprising the steps of:
a) contacting the seaweed extract with water to form a seaweed extract hydrogel,
b) mixing the seaweed extract hydrogel and a biodegradable filler to form a mixture, and
c) allowing the mixture to dry in order to form the composite.

Suitably the biodegradable filler is cork. In embodiments, step (a) comprises heating the mixture of the seaweed extract in water to a temperature in the range of approximately 70° C. to approximately 100° C. to form the seaweed extract hydrogel.

In embodiments, the method comprising the steps (a) to (c) of the method of producing a composite of the third aspect, and between steps (b) and (c) the additional step of: moulding the mixture into a shape or a three-dimensional form of the product.

In a fourth aspect, the invention provides a method of re-working a product, comprising producing a product by the method of the third aspect, wherein the method further comprises:
f) softening or melting the product by contacting the product with water or steam to provide a softened product;
g) further manipulating the softened product to provide a re-worked product, wherein the re-worked product has a different shape to the product;
h) allowing the re-worked product to dry to provide a dried re-worked product.

In a fifth aspect the invention provides a method of industrial biodegradation of the composite of the first aspect, or the product of the second aspect, the method comprising the step of exposing the composite or product to conditions in which the rate of biodegradation is increased.

In a sixth aspect, the invention provides a method of composting the composition of the first aspect, or the product of the second aspect, the method comprising the step of exposing the composition or product to conditions in which the composition or product degrades to form compost or material suitable for use in compost or as an additive to soil to be used as a soil fertiliser

### BRIEF DESCRIPTION OF THE DRAWINGS

One or more embodiments of the invention will now be described, by way of example only, with reference to the accompanying drawings, in which:

FIG. 1 shows an embodiment of a product formed of the composite of the present invention (Composite 1; Table 1) having a weight % ratio of carrageenan kappa/cork/water of 51/40/9, based on the total weight of the composition.

FIG. 2 shows an embodiment of a product formed of the composite of the present invention (Composite 2; Table 1) having a weight % ratio of carrageenan kappa/cork/water of 50/40/9, based on the total weight of the composition.

FIG. 3 shows an embodiment of a product formed of the composite of the present invention (Composite 3; Table 1) having a weight % ratio of carrageenan kappa/cork/water of 49/42/8, based on the total weight of the composition.

FIG. 4 shows an embodiment of a product formed of the composite of the present invention (Composite 4; Table 1) having a weight % ratio of agar/cork/water of 52/40/8, based on the total weight of the composition.

FIG. 5 shows a comparison of two composites in accordance with the present invention differing in the size of the cork granule used. (a) shows a composite (Composite 5; Table 1) having a weight % ratio of carrageenan kappa/cork/water of 49/42/8, in which the cork granules are 0.2 mm average diameter; (b) shows a composite (Composite 1; Table 1) having a weight % ratio of carrageenan kappa/cork/water of 51/40/9, in which the cork granules are 0.5 mm average diameter, all weight percentages, based on the total weight of the composition.

FIG. 6 shows a composition comprising sawdust as a biodegradable filler in accordance with the present invention (Composite 9; Table 1), cast and dried on the mould.

FIG. 7 shows a composition comprising tealeaves as a biodegradable filler in accordance with the present invention (Composite 10; Table 1), cast and dried on the mould.

FIG. 8 shows a composition comprising coffee grounds as a biodegradable filler in accordance with the present invention (Composite 11; Table 1), cast and dried on the mould.

### DEFINITIONS

For convenience, before further description of the present disclosure, certain terms employed in the specification, and examples, are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles ‘a’, ‘an’ and ‘the’ are used to refer to one or to more than one (i.e. to at least one) of the grammatical object of the article.

As used herein, the term ‘comprising’ means any of the recited elements are necessarily included and other elements may optionally be included as well. ‘Consisting essentially of means any recited elements are necessarily included, elements which would materially affect the basic and novel characteristics of the listed elements are excluded, and other elements may optionally be included. ‘Consisting of means that all elements other than those listed are excluded. Embodiments defined by each of these terms are within the scope of this invention. The term ‘comprising’, when used in respect of certain components of the composite, should be understood to provide explicit literal basis for the term ‘consisting essentially of and ‘consisting of those same components.

As used herein, the term ‘biodegradable’ means capable of being chemically and/or physically broken down in nature and/or by the action of living things. The term is used herein to refer to composites, or components within composites, that naturally break down to innocuous constituents in water or aqueous, or wet environments, typically through the action of microorganisms such as bacteria or fungi. The composite may comply with European standard EN 13432, or more generally that 90% of the material disintegrates to particle fragments having a size of no more than 2 mm after twelve weeks and biodegrades by at least 90% after six months (laboratory test method EN 14046). The term ‘hyper biodegradable’, as defined herein, may be used to refer to a material that has a particularly fast rate of biodegradation, for example, less than 6 months, suitably less than 3 months, to fully biodegrade in a natural, non-adapted environment, or waste stream. In this context the term ‘nature’ or ‘natural’ refers to a non-industrial environment and/or an environment that is not adapted to promote biodegradation, such as the open air or a domestic compost heap.

As used herein, the term ‘compostable’ means capable of being broken down in nature and/or by the action of living things for use as compost. Suitably, the term ‘compostable’ may be used to refer to composites or products that may be acceptably added to a composting site. The term ‘home compostable’, may be used to refer to composites or products that may be acceptably composted in a domestic environment, for example, added to a compost heap established in a domestic garden. The term may mean a plastic that conforms to the Australian norm AS 5810 “Biodegradable plastics - biodegradable plastics suitable for home composting”; the Belgian certified TÜV OK compost home certification scheme, requiring at least 90% degradation in 12 months at ambient temperature; and/or the French standard NF T 51-800 “Plastics -Specifications for plastics suitable for home composting”. The term ‘industrially compostable’ may be used to refer to composites or products that may be acceptably added to an industrial composting waste stream. An industrial compositing waste stream may, for example, involve an active compositing stage followed by curing. The active compositing phase typically lasts a minimum of 21 days and maintains a temperature in the compost heap of approximately 50° C. to 60° C. throughout this period. For hygienisation purposes, temperatures may remain above 60° C. for at least one week in order to eliminate pathogenic microorganisms. During the curing phase the rate of decomposition slows and the temperature lowers to < 40° C. with synthesis of humic substances.

As used herein, the term ‘non-hazardous’ means not toxic or presenting a risk to people and animals, or the environment. In terms of chemical compounds, non-hazardous may mean complying with any one or more of EC Regulation No 1907/2006, EC Regulation No 1272/2008, REACH Directive 1999/45/EC, No 76/769/EEC, European Council Directive 793/93 and 91/155/EEC, 93/67/EEC or 67/548/EEC; or achieving a toxicity category IV (practically non-toxic and not an irritant) according to Title 40 of the United States Code of Federal Regulations (156.62), or equivalents thereof.

The term ‘bioplastics’ is used herein to mean plastic materials produced from renewable biomass sources, such as vegetable fats and oils, corn starch, straw, woodchips, sawdust, recycled food waste, etc. Bioplastic can be made from agricultural by-products. Bioplastics indicates the source of the material from which the plastic is made as being biological. Bioplastics does not infer that the material is biodegradable, although some bioplastics may also be biodegradable.

The term ‘cork’ as used herein means a natural material obtained from the outer bark or trunk of a cork oak tree (sp: Quercus suber).

As used herein, the term ‘seaweed’ refers to the commonly used term for several groups of multicellular algae typically found in or close to the sea or bodies of fresh water. Types of seaweed include Rhodophyta (red), Phaeophyta (brown) and Chlorophyta (green) macroalgae. Many of the brown algae are referred to simply as kelp.

As used herein, the term ‘seaweed extract’ refers to a separated or isolated component or constituent part of seaweed. Suitably the method of separation or isolation is via chemical or physical extraction (i.e. gel press or precipitation in alcohol and alkaline hydrolysis). For example, the seaweed extract may be obtained by crushing of the seaweed plant, or part thereof, followed by filtration to remove the solid seaweed residue material; or alternatively, washing the seaweed with a suitable solvent, for example an alkaline aqueous solution, and collecting the desired extract as the, or part of, the insoluble matter that remains. The extract may be subject to further purification/separation steps. Examples of seaweed extract in accordance with the meaning herein are the extracts carrageenan, agar and alginate, suitably carrageenan.

As used herein the term ‘carrageenan’ refers to a family of linear sulphated polysaccharides extracted from red seaweed. There are three main varieties of carrageenan, which differ in their degree of sulfation. Carrageenan kappa has one sulfate group per disaccharide, carrageenan iota has two, and carrageenan lambda has three.

As used herein the term ‘thermally insulating’ means having a low thermal conductivity. The thermal conductivity of a material is a measure of its ability to conduct heat. It is commonly denoted by k, λ, or κ. Heat transfer occurs at a lower rate in materials of low thermal conductivity than in materials of high thermal conductivity. For instance, metals typically have high thermal conductivity and are very efficient at conducting heat, while the opposite is true for insulating materials like expanded polystyrene (or Styrofoam®). Thermal conductivity is often calculated using Fourier’s Law for heat conduction (q=-kVT)., where q is the heat flux, k is the thermal conductivity and ∇T is the temperature gradient.

As used herein the term ‘binder’ means the matrix in a composite material that holds or binds the filler or aggregate together. The binder may be the entire material that exists in a composite that it not the filler, or the binder may refer to the material to binds the filler together but other materials may exist in the composite, or be mixed with the binder to provide the composite material.

As used herein the term ‘filler material’ or simply ‘filler’, or ‘bio-aggregate’ means particles added to resin or binders to improve specific properties, make the product cheaper, or both. A ‘natural organic filler’ is a filler that derives from natural sources such as plants or animals. A ‘biodegradable filler’ is a filler in a composite that is able to biodegrade as defined elsewhere herein. Examples of biodegradable fillers may be cork, for example cork granules of various sizes, tealeaves, coffee granules, sawdust, hemp fibre, hay, straw, dried and granulated food waste etc.

As used herein, the term ‘biodegradable composite’ means any hybrid material of at least two phases in which either the filler or matrix (binder) or both must be chosen from biodegradable sources. Suitably, a biodegradable composite means the filler and matrix (binder) must both be chosen from biodegradable sources.

### DETAILED DESCRIPTION

The present invention relates to a biodegradable thermally-insulating composite material that decomposes fully and rapidly (hyper biodegradable) in the environment, particularly in aqueous or otherwise non-dry environments of various kinds, or in waste streams, or composting yet maintains one, more or all of the benefits of petroleum-based plastic, or plant-based bioplastic, thermally-insulating materials, during its lifetime of use.

The thermally-insulating composite material of the present invention generally comprises a seaweed extract and a biodegradable filler or bio-aggregate, suitably cork, tealeaves, coffee granules, sawdust, hemp fibre, hay, straw, dried and granulated food waste, granulated plant seeds, dried and granulated fruit and vegetable peel/skin. Suitably the biodegradable filler is cork, suitably cork granules. The composite may further comprise water. Suitably the composite comprises a seaweed extract, a biodegradable filler and water. Suitably the composite consists essentially of a seaweed extract, a biodegradable filler and water. Suitably the composite consists of a seaweed extract, a biodegradable filler and water.

In embodiments, the seaweed extract may be a carrageenan, agar, or a mixture thereof. The family of carrageenan compounds and agar are well-known in the food, pharma and personal care product fields; however, they are chemically distinct. Carrageenans comprise repeat units of β-D-galactose-cc-D-galactose, while agar comprises repeated β-D-galactose-α-L-galactose. Suitably, the seaweed extract used in the composite of the present invention is a carrageenan. More suitably, the carrageenan may be carrageenan kappa.

It is contemplated that any seaweed extract may be useful in the present invention. As would be expected however, while carrageenans, agar and other seaweed extracts have a common source (seaweed), and related chemical structures, each substance has differing properties when forming hyper biodegradable replacement materials therefrom. For example, carrageenans, in particular, carrageenan kappa, when mixed with a biodegradable filler, for example cork, as in the present invention displays surprisingly beneficial mechanical material properties compared to agar and other seaweed extracts.

In embodiments, the biodegradable filler material may be obtained from a natural organic material or from a mixture of natural organic materials, which are normally of plant origin. Suitably, the biodegradable filler material is cork, tealeaves, coffee granules, sawdust, hemp fibre, hay, straw, dried and granulated food waste, granulated plant seeds, dried and granulated fruit and vegetable peel/skin. Suitably the biodegradable filler is cork. Suitably, the biodegradable filler may be present in the composite as cork, suitably cork granules or particles or powder.

In embodiments, the filler material may have a particular particle size chosen for the physical or mechanical properties of the composite or driven by the commercial availability of the filler material. For example, the cork granules according to the present disclosure particularly comprises particles having a particle size measured according to ISO 2030: 1990, in the range of from 1 µm to 2 cm, particularly in the range of from 1 µm to 1.5 cm, more particularly in the range of from 0.1 cm to 1.2 cm, even more particularly in the range of from 0.1 cm to 1 cm, yet more particularly in the range of from 0.1 cm to 0.9 cm, even more particularly in the range of from 0.2 cm to 0.8 cm, even more particularly in the range of from 0.2 cm to 0.5 cm

In embodiments, the thermally-insulating composite material comprises only a seaweed extract, such as a carrageenan a biodegradable filler, suitably cork, tealeaves, coffee granules, sawdust, hemp fibre, hay, straw, dried and granulated food waste, granulated plant seeds, dried and granulated fruit and vegetable peel/skin, suitably cork, suitably cork granules, with the remainder of the composite being water. In other words, and as defined herein, the composite may consist of a seaweed extract and a biodegradable filler, a seaweed extract and a biodegradable filler and water. In other words, the weight percentages of these components may add up to 100% by weight based on the total weight of the thermally-insulating composite material.

In embodiments, it is contemplated that other additives may be included in the composite that may provide one or more benefits without detrimentally affecting the overall properties of the composite. In other words, and as defined herein, the composite may consist essentially of a seaweed extract and a biodegradable filler, suitably cork, tealeaves, coffee granules, sawdust, hemp fibre, hay, straw, dried and granulated food waste, granulated plant seeds, dried and granulated fruit and vegetable peel/skin, suitably cork, or a seaweed extract and a biodegradable filler, suitably cork, tealeaves, coffee granules, sawdust, hemp fibre, hay, straw, dried and granulated food waste, granulated plant seeds, dried and granulated fruit and vegetable peel/skin, suitably cork, and water. The term ‘minor additives’ or ‘additives’ is intended to relate to additives otherthan a seaweed extract and a biodegradable filler that may be present in the composite in an amount of 40 wt% or less. Suitably, less than 35 wt%, 30 wt%, 25 wt%, 20 wt%, 15 wt%, 10 wt%, 5 wt%, 2 wt%, 1 wt%. All weight percentages are based on the total weight of the composite. In other words, the weight percentages of the seaweed extract, the biodegradable filler, suitably cork, tealeaves, coffee granules, sawdust, hemp fibre, hay, straw, dried and granulated food waste, granulated plant seeds, dried and granulated fruit and vegetable peel/skin, suitably cork, water and the additive(s) may add up to 100% by weight based on the total weight of the composite.

The additives or minor additives may be, although not limited to: inorganic salts such as sea salt, table salt, potassium chloride or calcium chloride; hydrocolloids, xanthan gum, gum arabic, MC, CMC, HPMC; calcium carbonate; glycerine; apple puree; starch; montmorillonite (MMT); plant oils; cinnamon bark oil; soybean oil; glycerol; silver nanoparticles; grapefruit seed extract; zataria multifloro essential oil; nonoclay or clay mineral; polyethylene glycol (PEG); chitin; arabinoxylan; banana powder; gelatin; titanium oxide nanoparticles. Alternatively, in embodiments, the composite of the present invention, and products formed therefrom, may lack any minor additives, including but not limited to one or more of those listed above.

In embodiments, the composite may comprise a salt, more suitably an alkali metal salt or an alkaline earth metal, even more suitably a lithium, sodium, calcium or a potassium salt. Most suitably, the composite may comprise a potassium salt. In embodiments, the potassium salt is potassium chloride. Suitably, the composite may comprise the salt in an amount in the range between 0.1-5 % by weight, more suitably in the range between 0.5-3 % by weight, even more suitably in the range between 0.5-1.5 % by weight. Suitably, the salt may be present in the composite in an amount of at least 0.1 % by weight, 0.2% by weight 0.3 % by weight, 0.4% by weight, 0.5% by weight, 0.6% by weight, 0.7% by weight, 0.8% by weight, 0.9 % by weight, 1.0% by weight, 2.0% by weight, 3.0% by weight, 4.0% by weight or above. Suitably the salt may be present in the composite in an amount of at most 5.0% by weight, 4.0% by weight, 3.0% by weight, 2.0 % by weight, 1.9 % by weight, 1.8 % by weight, 1.7 % by weight, 1.6 % by weight, 1.5 % by weight or below; all weight percentages are based on the total weight of the composite. Without wishing to be bound by theory, it is believed that the inclusion of such salts can increase the rigidity of the resulting composite and products formed therefrom.

In embodiments, the composite may comprise vegetable oils or extracts or derivatives thereof, such as glycerol. More suitably, the composite may comprise glycerol in an amount in the range of 0.1-40 % by weight, even more suitably in the range of 10-35 % by weight, more particularly 25-35 % by weight, all weight percentages are based on the total weight of the composite. Without wishing to be bound by theory, it is believed that the inclusion of vegetable oils such as glycerol can increase the flexibility of the resulting products.

In embodiments, the composite material may comprise the seaweed extract in an amount of 40-95 % by weight, suitably 50-95 % by weight, more suitably 50-70 % by weight. Suitably the composite material may comprise the seaweed extract in an amount of at least 40 % by weight, 45 % by weight, 50 % by weight, 55 % by weight, 60 % by weight, 65 % by weight, 70 % by weight, 75 % by weight, 80 % by weight, 85 % by weight, or 90 % by weight. Suitably the composite material may comprise the seaweed extract in an amount of at most 95 % by weight, 90 % by weight, 85 % by weight, 80 % by weight, 75 % by weight, 70 % by weight, 65 % by weight, 60 % by weight, 55 % by weight, 50 % by weight, or 45 % by weight. All weight percentages are based on the total weight of the composite material.

In embodiments, the composite material may comprise the biodegradable filler, suitably cork, tealeaves, coffee granules, sawdust, hemp fibre, hay, straw, dried and granulated food waste, granulated plant seeds, dried and granulated fruit and vegetable peel/skin, suitably cork, in an amount of 5-50 % by weight, more suitably 20-50 % by weight or 30-50 % by weight. Suitably the composite material may comprise the biodegradable filler in an amount of at least 5 % by weight, 10 % by weight, 15 % by weight, 20 % by weight, 25 % by weight, 30 % by weight, 35 % by weight, 40 % by weight, or 45 % by weight. Suitably the composite may comprise the biodegradable filler in an amount of at most 50 % by weight, 45 % by weight, 40 % by weight, 35 % by weight, 30 % by weight, 25 % by weight, 20 % by weight, 15 % by weight, or 10 % by weight. All weight percentages are based on the total weight of the composite material.

In embodiments, the composite material may comprise 1-20 % by weight water, even more particularly 2-15 % by weight, all weight percentages are based on the total weight of the composite material. Suitably the composite material may comprise the water in an amount of at least 2 % by weight, 3 % by weight, 4 % by weight, 5 % by weight, 6 % by weight, 7 % by weight, 8 % by weight, 9 % by weight, 10 % by weight, 11 % by weight, 12 % by weight, 13 % by weight, or 14 % by weight. Suitably the composite may comprise the water in an amount of at most 15 % by weight, 14 % by weight, 13 % by weight, 12 % by weight, 11 % by weight, 10 % by weight, 9 % by weight, 8 % by weight, 7 % by weight, 6 % by weight, 5 % by weight, 4 % by weight, or 3 % by weight. All weight percentages are based on the total weight of the composite material.

In a specific embodiment of a composite material in accordance with the present invention, the composite material may comprise carrageenan kappa in an amount of 50-90 % by weight or suitably 45-55 % by weight (in embodiments, a minimum of 48 % by weight seaweed extract is needed based on the data provided, however with 50-60 % by weight seaweed extract superior results can be achieved), cork granules in an amount of 10-60 % by weight or suitably 30-45 % by weight (in embodiments, a maximum of 43 % weight cork is needed based on the data provided, however, the cork percentage could be as low as 10 % by weight), water in an amount of 4-25 % by weight or suitably 6-10 % by weight. All weight percentages are based on the total weight of the composite material. In embodiments, the weight percentages of carrageenan kappa, cork and water may add up to 100% by weight based on the total weight of the composite material.

The thermally-insulating composite material of the present invention is hygroscopic, i.e. it absorbs water. Without wishing to be bound by theory it is believed that the exceptional biodegradability, or hyper biodegradability, of the composite of the present invention is, at least in part, due to its ability to absorb water which, along with the major components of the composite being a natural food source, encourages and facilitates the growth of the microorganisms such as bacteria or fungi on the composite that that lead to its biodegradation.

The seaweed binder of the thermally-insulating composite material of the present invention can absorb significant amounts of water without losing integrity or leaking or splitting. For example, the seaweed binder may absorb approximately 10-13 grams of water per gram of material leading to an approximately 1,000 % to 1,300 % change in weight of the binder on exposure to water.

A particular advantage of the composites of the present invention is that the material is thermally-insulating, i.e. has a low thermal conductivity. A low thermal conductivity is important in various applications, including heat insulation, for example as a container for warm or hot drinks, or as a packaging material where the contents are intended to be kept at a temperature above or below the ambient temperature. It is anticipated that the composites of the present invention are also electrically insulating to a least some degree.

A further advantage of the composites of the present invention is that by incorporating fillers, for example cork, which have an inherently low density, the composites are light per unit volume, i.e. have a low density. This may be particularly advantageous in applications that require reduced weight, such as large containers, or that can float.

In addition, the propensity of the composite of the present invention to absorb water on contact encourages microorganism growth and thereby promotes rapid (<2 months) and significant biodegradation in contact with water in the air, for example, humidity or precipitation (urban roadside-type environment), in compost, in waste streams, or in sewers, the sea or rivers. In addition, and without wishing to be bound by theory, it is postulated that the ability of the material to absorb water in this way, and then release it again by evaporation is a factor in its rapid physical degradation due to the stresses created in the material through wetting and drying cycles leading to collapse and fragmentation of the material structure.

It would also be expected that at least part of the composite of the present invention also disintegrates and/or dissolves in digestive tract fluids. Therefore, in view of the innocuous and food-safe components, it is anticipated that the composite is non-hazardous for human and/or animal consumption, i.e. the material is, in principle at least, edible. As seaweed extract, in particular, carrageenans and agar, for example, are common additives in many food products, it is a feature of the composites of the present invention that the composite is food safe. As the composite contains cork, saw dust, etc. some components may not be digestible by all animals. It is anticipated that, the seaweed binder of the composite material may be soluble in water at a temperature of at least 50° C., more particularly at least 75° C., even more particularly at least 85° C. The length of time required for dissolution depends at least partially on the form, or shape, and thickness of the material sheet material wall thickness of approximately 1 mm, complete dissolution would be expected within 1 hour at 85° C. with continuous mixing.

While the composite of the present invention, or products formed therefrom, exhibit surprisingly beneficial properties in terms of biodegradability in the environment or in water, the composites, or products formed therefrom, when stored in relative humidity conditions of 80% or less may exhibit a shelf life prior to use of up to 3 years, more particularly 2-3 years.

In a further aspect, the invention relates to products comprising or formed from the biodegradable thermally-insulating composite material described above. In embodiments, the product may be a shaped article, such as a sheet or film, or the product may be a three-dimensionally shaped article. Suitably the three-dimensionally shaped article may be generally shaped as plate or planar sheet, or as a regular or irregular sphere or spheroid, a cube or cuboid, an ellipsoid, a cylinder, a cone, a prism, a pyramid, or a combination of these. Suitably, the product may be packaging material. Suitably, the packaging material may be a container or part thereof. Suitably, the container or part thereof may be a cup, tray, punnet, clamshell, box, bottle, tube or lid. Suitably the container, or part thereof may be packaging material, in particular, packaging material for perishable goods such as food. In addition to packaging, the invention also relates to other single-use consumer products such as drinking straws, cups, a plate, or a food tray formed from the composite described above. The surprising structural rigidity of the and other material properties of the composite make it particularly suited to use in structural three-dimensional products with thin walls, such as packaging material and cups.

In embodiments, the thickness of the product may be appropriate for the use. Suitably, the products of the invention, when for example the products are biodegradable packaging material or cups, may have a thickness (minimum distance between two surfaces of the product) of 10 mm or less (because of the cork granule size the thickness of the material can increase up to 10 mm). Suitably, the products may have a thickness of at most 9 mm, 8 mm, 7 mm, 6 mm, 5 mm, 4 mm, 3.5 mm, 3.0 mm, 2.5 mm, 2.0 mm, 1.5 mm, 1.0 mm, 0.5 mm, 0.4 mm, 0.3 mm. or 0.2 mm or less. Suitably, the products may have a thickness of at least 0.1 mm, 0.2 mm, 0.3 mm, 0.4 mm, 0.5 mm, 0.6 mm, 0.7 mm, 0.8 mm, 0.9 mm or 1.0 mm, 1.5 mm, 2 mm or more. Each of these thicknesses can be used in three-dimensional products that are structural and load bearing.

In embodiments, the thermally-insulating composite material of the present invention forms on moulding and subsequent drying a resilient, self-supporting structure with the ability to support loads and/or hold beverages properties similar to that of petroleum-based plastic or bio-based composite materials. The rigid and high tensile strength properties of the composite of the present invention allows use of the material to form ‘structural packaging’ i.e. packaging or products that form a three-dimensional, load bearing structure without exterior support of structures, as well as liners or coatings supported by other structures or products. Without wishing to be bound by theory, it is believed the seaweed extract, suitably carrageenans, in particular carrageenan kappa, that provides the surprisingly beneficial properties in terms of structure and load bearing to the composite.

The composite of the present invention, or products formed therefrom may accept printed media, for example water-based or oil-based inks. The composite of the present invention, and products formed thereof may suitably be moulded to show embossed detail present on the mould. The structural rigidity of the products, similar to that of petroleum-based plastic- or bioplastic composite materials, means that it would be expected that products of the present invention would be able to be used in current printing machinery without modification.

The products of the invention, for example the packaging materials, may exhibit useful oxygen barrier properties. This can mean that the packaging material will keep the contained items fresher for longer and increase their shelf-life.

In another surprising benefit of the present invention it has been found that food packaging made from or comprising the thermally-insulating composite material of the present invention can lead to an enhanced shelf life for food, suitably fresh food, vegetables or dairy products such as cheese, contained therein, as compared to traditional petroleum-based plastics such as, for example, polyethylene terephthalate (PET) or bioplastics such as PLA. The hygroscopic nature of the composite means that any ambient moisture inside the packaging is absorbed, and retained by, the composite meaning the environment in which the food is stored becomes less suitable for microorganism growth that is typically responsible for mould growth and decay. This, alongside the oxygen barrier properties of the composite, retards decomposition of the food within the packaging and lengthens the food’s shelf life as a result.

In embodiments, the shelf life (defined as the length of time for which an item remains fit for consumption, or saleable) of produce or perishable goods contained within a product or structural stock keeping units (SKUs) may be extended by at least 10 % at a given temperature. Suitably, the shelf life may be extended by at least 20 %, 30 %, 40 %, 50 %, 60 %, 70 %, 80 %, 90 %, 100 %, 200 %, 300 %, 400 %, 500 % or more.

In a further aspect, this invention relates to a method of preparing a thermally-insulating composite material as defined above, the method comprising the steps of:
(a) contacting a seaweed extract with water, or other suitable polar solvent, to form a seaweed extract hydrogel;
(b) mixing the seaweed extract hydrogel and a biodegradable filler to form a mixture;
(c) allowing the mixture to dry in order to form the composite.

The seaweed extract in step (a) and/or the biodegradable filer in step (b) may as defined elsewhere herein. Suitably the seaweed extract is carrageenan kappa. Suitably the biodegradable filer, maybe any particulate materials defined as biodegradable. Suitably the biodegradable filler is selected from the group consisting of: cork; dried tealeaves; coffee granules; sawdust; hemp fibre; hay, straw, dried and granulated food waste, granulated plant seed, dried and granulated fruit and vegetable peel or skin, more suitably cork granules.

Suitable the polar solvent in step (a), aside from water, may be any polar solvent that can form suitable hydrogels with the seaweed extract. Suitably, the polar solvent has a boiling point that allows drying of the formulation after moulding. Suitably, the solvent is non-hazardous and not damaging to the environment. Polar solvents in this context may include, but are not limited to, ethanol, methanol, propanol, butanol, acetone, ethyl acetate and dimethylsulfoxide.

In embodiments, in step (a) seaweed extract, suitably in powder form, is mixed, or otherwise combined, with cold water to form a paste. Any additive, such as glycerol, to be added may be suitably added at this stage. This paste is then heated, suitably with mixing, to an elevated temperature. On heating, the seaweed extract hydrogel is formed. Suitably, the elevated temperature may be 80° C. or more, more suitably 80-100° C., even more suitably 90-100° C. In embodiments, the paste may be held at the elevated temperature for between approximately 20 minutes and approximately 4 hours. Suitably, contact is for between approximately 1 hour and approximately 3 hours. Most suitably, contact is for approximately 2 hours.

In embodiments, in step (a) the concentration of seaweed extract in the seaweed extract hydrogel may be 1-10 % w/v in the seaweed extract hydrogel, even more suitably 1-8 % w/v, more suitably 5-6 %. In embodiments, after step (a), further water, or other suitable polar solvent as appropriate is added to the hydrogel to achieve the desired viscosity. Suitably the consistency of the seaweed extract hydrogel used in step (b) is a liquid. The total amount of water in the hydrogel may be between 100% to 300% of the original volume of water added in step (a).

In embodiments, in step (b) the concentration of biodegradable filler in the mixture may be between 2-10 % by weight, more suitably 4-6 % by weight.

In embodiments, step (a) may be conducted at an elevated temperature. Suitably, contact may be at a temperature greater than 80° C., more suitably in the range from 80° C. to 100° C., even more suitably 90 to 100° C.

In embodiments, heating may be continued, or re-commenced in step (b). During mixing in step (b), which in embodiments is approximately 30 min, the mixture is heated to 90° C. After the mixing is completed the heat is removed and the mixture is allowed to cool.

On forming the seaweed extract hydrogel, foaming may occur due to bubble formation in the mixture. Foaming may continue throughout the heating in step (b). The foam may be removed at any time during or following step (b), and removal of the foam formed may be repeated. The de-foaming may be applied in both step (a) and/or (b). Removal of the foam may be pre-empted by, or conducted concurrently with, degassing of the mixture. Degassing or other forms of removal of bubbles from the solution may be conducted on its own without foam removal. Such degassing may comprise stirring the mixture during heating to encourage release of bubbles from the mixture. Other forms of degassing, such as ultrasonic treatment and vibration, under atmospheric pressure or under reduced pressure (vacuum) may be used instead or in addition and are also contemplated. Suitably, the mixture will be degassed for approximately 2 hours to approximately 8 hours. Suitably, approximately 2 hours to approximately 6 hours. Most suitably, degassing is performed for approximately 3 to approximately 4 hours. Suitably the degassing occurs with or directly after heating in step (a) and/or (b).

The final concentration of the components at the end of step (b) may be in the range of between 1 to 12 wt%, suitably between 5-7 wt% seaweed extract, in the range of between 3 to 5 wt%, biodegradable filler and in the range of between 80 wt% to 90 wt% water or other suitable polar solvent. All weight percentages being based on the total weight of the mixture at the end of step (b).

Mixtures that have a higher viscosity (before being drying) result (when dried) in denser, more structural products, If the prepared mixture has a lower viscosity (before drying) the resulting (dried) product, is generally less dense.

In embodiments, the method may comprise, in step (a), and/or (b), the step of adding one or more additives as defined elsewhere herein. The additives may be dyes or pigments. These can give colour to the composite. Other additives may be a salt or glycerol as described above. Suitably, salt or glycerol may be added to the mixture produced in step (a).

In a further aspect, this invention relates to a method of producing a product as defined above. The method comprises steps (a)-(c) as defined above for forming the composite, and, between steps (b) and (c), the step of forming or moulding the mixture in a shape of the product.

The forming step may comprise moulding. Suitably, moulding may comprise casting, extrusion moulding, compression moulding, press-moulding, injection moulding, rotational moulding or slip forming, blow moulding. Most suitably the moulding is press moulding.

The moulding technique may be selected to be suitable for mass manufacturing, for example injection moulding, press moulding, or casting.

The material is generally added to the mould at above ambient temperature to retain the required fluidity of the mixture. Suitably the material is added to the mould at approximately 80° C. to 100° C., or more suitably 85° C. to 95° C. In embodiments, the material is added to the mould at approximately 70° C., 75° C., 80° C., 85° C., 90° C., 95° C. or 100° C. Suitably, the material is added to the mould at approximately 90° C. Below 70° C., the material may solidify complicating or preventing suitable moulding.

When the liquid composite hydrogel with the biodegradable filler cools and solidifies (after an appropriate time), the mould can then be separated, and the material left on at least one of the male or female part of the mould, suitably the male part of the mould (or mandrel) to expose the solidified composite to a drying environment, and thereby promote drying of the composite though evaporation of the solvent, suitably water, from the solidified gel. This process of drying will typically continue until the composite has become suitably rigid and self-supporting (through the process of drying) such that it can be demoulded, resulting in the finished product. In some embodiments, the finished product has an appearance and properties comparable to PET plastic and PLA bioplastic. Furthermore, by retaining the solidified gel on the male mould or mandrel during drying, shrinkage is controlled and deformation is prevented in the finished product.

In embodiments where the material is at least partially cooled in the mould, the composite is cooled in the mould to ambient temperature. Suitably the composite may be cooled to a temperature below approximately 40° C., and above approximately 0° C. Suitably, the composite may be cooled to a temperature of approximately, or exactly, 30° C., 25° C., 20° C., 15° C., 10° C., 5° C.

In embodiments, the composite of the present invention may be dried at room temperature, pressure or osmosis. In embodiments, the composite may be dried in a controlled atmospheric environment, for example, a low humidity environment or an environment where humidity is below that of the ambient atmosphere, or under reduced atmospheric pressure, or under ultraviolet (UV) light. The composite may also be dried via osmosis in brine (salt and water bath solution), salt granules/powder or in corn or wheat flour/powder. Suitably, the means of drying the composite may be in a vacuum oven in which the boiling point of water is reduced. This method is often used for heat sensitive materials such as the composite of the present invention.

The use of heat to further encourage drying may be applied in addition to, or instead of, other methods of drying, including those described above, although care must be taken not to melt the composite. In embodiments, the composite may be dried at a temperature below 60° C. Suitably, the composite may be dried at a temperature of between 30° C. and 60° C., or between 30° C. and 50° C., most suitably 40° C. Suitably, the composite may be dried at a temperature of at least 30° C., 40° C., or 50° C. Suitably, the composite may be dried at a temperature of at most 60° C., 50° C., 40° C., or 30° C. In reduced atmospheric pressure drying environments, such as a vacuum oven, the desired heating temperatures may be lowered compared to drying in ambient atmospheric conditions.

In other embodiments, or in addition to those embodiments described above, the atmosphere over the mould containing the composite during the drying step may have a low relative humidity. Suitably the relative humidity of the atmosphere over the composite may be approximately 70% or below. Suitably, the relative humidity of the atmosphere over the mould may be between 50% and 70%. Suitably, the relative humidity of the atmosphere over the mould may be approximately 60%, 55%, 50%, 45%, 40% or below.

In other embodiments, or in addition to those embodiments described above, the atmosphere over the mould containing the composite during the drying step may be at a pressure below ambient atmospheric pressure. Suitably, the pressure of the atmosphere over the mould during the drying step may be 7 to 14 psi. Suitably the pressure is at most 14 psi, 13 psi, 12 psi, 11 psi, 10 psi, 9 psi, 8 psi, 7 psi or below. Suitably the pressure is at least 1 psi, 2 psi, 3 psi, 4 psi, 5 psi, 6 psi, 7 psi or above.

Drying can be, for example, at room temperature, in a dehumidifier (max. approximately 60° C.) and/or in a vacuum oven (max. approximately 60° C.).

In embodiments, it is anticipated that products may be re-worked from a sheet of the composite of suitable thickness. The re-working may comprise firstly forming a sheet of the composite of the present invention, for example by pouring or depositing the mixture derived from step (b) above onto a flat surface, and then cooling and then drying the composite similar to the manner described above in the context of press moulding. In embodiments the sheet is pinned to the flat surface, suitably by a suitable weight, for example a plate, to prevent shrinkage or deformation during drying. The sheet formed of the composite may then be steamed and/or heated in the presence of water, for example by placing in hot water (above 80° C.) for an appropriate length of time, for example 5 seconds, and then be re-worked into a desired shape. Suitably, re-working may be by a process of wrapping, and then holding, the sheet to the contours of a suitable former. Once the composite has cooled and/or dried sufficiently to form the product, the former may be removed. Re-working may be performed using vacuum forming by applying a vacuum to the sheet such that it is pulled tightly over a suitable former. For re-working, the sheet may have a suitable thickness prior to reworking (i.e. in its shortest dimension) of 0.0 0.1 mm to 10 mm, more particularly 1 mm to 5 mm, even more particularly 0.5 mm to 1.5 mm.

In a further aspect, the invention also relates to a method of dissolving, degrading, biodegrading or otherwise safely decomposing the composite or product of the earlier aspects of the present invention described above. Alongside the material’s ability to fully biodegrade rapidly (less than 4-6 months) in a range of environments, both naturally occurring and man-made such as industrial composting facility, the option of dissolving the composite in water may be important in respect of the management of waste streams.

Specifically, the ability of the seaweed binder of the composite to readily dissolve in water may be advantageous in helping to prevent the product/composite from contaminating plastic recycling waste streams if wrongly discarded in a recycling bin by the consumer (the composite is intended for composting waste streams), by facilitation its separation at the point where recyclable plastics are submersed in liquid and washed prior to processing. Only the seaweed content in the composite can be dissolved in water however the biodegradable filler, such as cork, in the composite is not soluble in water. Once the seaweed content is dissolved then the biodegradable filler, suitably cork would take the granule form again and still be separated from plastics and not cause any disruption during the plastic recycling process.

In embodiments of the composite, or products derived therefrom, the method of dissolving the composite or product comprises the step of contacting the composite or product with liquid water at a temperature of at least 50° C., more particularly at least 70° C., even more particularly at least 85° C. In this method, the composite may comprise the seaweed extract in an amount of 40-90 % by weight, more particularly 60-600 % by weight. In particular, the composite may comprise the biodegradable filler in an amount of 5-60 % by weight, more particularly 30-50 % by weight. More particularly, the composite may comprise 1-20 % by weight water, even more particularly 2-15 % by weight. Suitably, the composite is contacted with the water at a temperature of 90° C. for between 30 minutes to 1 hour with continuous stirring to effect dissolution.

The ability to dissolve the composite of the present invention, or products derived therefrom, to innocuous, food-safe, water-soluble components has the advantage of providing a simple and reliable waste disposal stream. While the composite and or products will fully and rapidly biodegrade in the environment should this be necessary. The above method provides a means of easy disposal of the composite or products when disposed of through an appropriate managed waste stream. The ability of the composite to dissolve in water dependent on its temperature allows selection of a particular composite for a given use, dependent on the environment, its intended timescale and envisaged waste stream of that use.

### EXAMPLES

### Example 1 - Specific Method For The Preparation of a Thermally-Insulating Composite/Composition In Accordance With The Present Invention

Carrageenan Kappa in powder form (30 g) was added to 500 g of water (20° C.) before being mixed for 5 minutes. In embodiments where glycerol is added, it may be added at this stage. The resulting paste was warmed to 90° C. by being placed in a hot water bath (90° C.). As the mixture increased in temperature and reached 90° C. it became a liquid gel (hydrogel). The mixture was held at 90° C. for 2 hours. Any foam that had collected was removed from the hydrogel mixture.

A biodegradable filler (24 g to 40 g) was then added to the hot Carrageenan Kappa gel and mixed for 30 minutes at 90° C. temperature. Any foam that had collected was removed from the biodegradable filler-hydrogel mixture.

A moulded product was produced by pouring the hot prepared solution at 90° C. into female moulds. Male moulds were then pressed into the female moulds (i.e. press moulding) and the solution allowed to cool to 25° C. whereupon the hydrogel solidified. The mould was then separated and the solidified biodegradable filler-gel, attached to the male part of the mould, was then left to dry at 60° C. at ambient pressure and humidity until it dried completely (approx. 8 hours).

The resulting moulded product comprised the proportions of seaweed extract, water and filler as shown in Table 1 (contents by weight, based on the total weight of the composition).

The relative weight percentages were calculated based on a water content determined by comparison of the weight of the solidified gel prior to moulding and the final weight of the product. It is assumed that there was no loss of material mass of the biodegradable filler, and Carrageenan Kappa through the preparation, or loss of water during preparation prior to drying.

The resulting packaging is fully biodegradable and thermally insulating, and dissolves to the biodegradable filler in hot water at 80° C. and above.

For examples using cork as the biodegradable filler, the cork granules had an average particle size of 0.1 mm - 0.3 mm; or 0.3 mm - 0.8 mm.

For examples using sawdust as the biodegradable filler, the sawdust was obtained as a waste material from wood processing and had an average particle size of 0.5 mm.

For examples using tealeaves as the biodegradable filler, the tealeaves were obtained as a waste material from the beverage industry having been brewed with boiling or near boiling water, pressed and then discarded. The pressed tealeaves were further dried to around 8-15 wt% water for storage to eliminate mould forming. The tealeaves had an average particle size of 0.5 mm.

For examples using coffee grounds as the biodegradable filler, the coffee grounds were obtained as a waste material from the beverage industry having been brewed with boiling or near boiling water, pressed, filtered and then discarded. The pressed coffee grounds were further dried to around 8-15 wt% water for storage to eliminate mould forming. The coffee grounds had an average particle size of 0.5 mm.

For examples that make use of glycerol as an additive, 30 grams of glycerol was added where indicated in the general experimental above and the resulting composition comprised 27-32 wt% Carrageenan Kappa, 27-32 wt% glycerol, 26-36 wt% cork granules and 10 wt% water (contents by weight, based on the total weight of the composition).

### Example 2 - Preparation of Exemplified Compositions

Compositions 1 to 7 in accordance with the present invention were prepared in accordance with the general method of Example 1, replacing and/or adapting the seaweed product and proportions of components as appropriate.

Comparative composition 8 which is not in accordance with the invention was also prepared in accordance with the general method of Example 1, omitting cork granules from the composition. A summary of Compositions 1 to 8 is provided in Table 1:

TABLE 1

| Composition | Seaweed extract / g | Water / g | Biodegradable filler / g | Average filler granule size | Dry material wt% of the total composition (seaweed extract/filler/water) |
|---|---|---|---|---|---|
| 1 | CK / 30 | 500 | Cork granules / 24 | 0.5 mm | 51/40/9 |
| 2 | CK / 30 | 500 | Cork granules / 33 | 0.5 mm | 50/41/9 |
| 3 | CK / 30 | 500 | Cork granules / 40 | 0.5 mm | 49/42/9 |
| 4 | CK / 30 | 500 | Cork granules / 24 | 0.2 mm | 52/40/8 |
| 5 | CK / 30 | 500 | Cork granules / 33 | 0.2 mm | 50/41/9 |
| 6 | CK / 30 | 500 | Cork granules / 40 | 0.2 mm | 48/43/9 |
| 7 | Agar | 500 | Cork granules / 24 | 0.5 mm | 51/40/9 |
| 8 | CK / 30 | 500 | 0 | - | 48/43/8 |
| 9 | CK / 30 | 500 | Sawdust / 40 | 0.5 mm | 48/43/9 |
| 10 | CK / 30 | 500 | Tealeaves / 40 | 0.5 mm | 48/43/9 |
| 11 | CK / 30 | 500 | Coffee grounds / 40 | 0.5 mm | 48/43/9 |

### Example 3 - Thermal Insulation

The ability for embodiments of the compositions of the present invention to retard the loss or transmission of heat (thermal insulation test) was conducted with containers made using compositions of the present invention comprising different seaweed extracts; CK and Agar and different biodegradable fillers, and for embodiments using cork, different size cork granules.

In order to measure the effect of the thermal insulation of the biodegradable filler amount in the compositions, seaweed extract and water contents were kept the same. On the other hand, biodegradable filler amounts were increased by weight. The containers used were prepared using the general method of Example 1 and by forming each composition in the same mould meaning they were extruded into the same volume.

As a control, another composition was prepared with only seaweed extract and water with no added cork granules (Composition 8) to illustrate the thermal insulation effect of the cork granules in the seaweed extract compositions.

In a room temperature outside environment, ice cubes were placed in each test container. 10 minutes later the surface temperature of each container is measured with an infrared thermometer from outside.

The results are shown in Table 2:

TABLE 2

| Composition | Material surface temperature on the outside/°C | Inside temperature of the container/°C | Outside Temperature/°C |
|---|---|---|---|
| 1 | 23 | -5 | 25 |
| 2 | 23 | -5 | 25 |
| 3 | 24 | -5 | 25 |
| 4 | 21 | -5 | 25 |
| 5 | 22 | -5 | 25 |
| 6 | 22 | -5 | 25 |
| 8 | 10 | -5 | 25 |
| 9 | 20 | -5 | 25 |
| 10 | 18 | -5 | 25 |
| 11 | 17 | -5 | 25 |

The results show that all compositions in accordance with the present invention (Compositions 1 to 6) and 9 to 11 provide good thermal insulation ability. It appears in general that cork offers the better results and it appears slightly better results are achieved with larger cork particle sizes (Compositions 1 to 3). In contrast, the seaweed-based composition that has no biodegradable filler in it showed the lowest thermal insulation ability (Composition 8). According to the results, there is a clear advantage in using biodegradable fillers, and in particular, cork granules in seaweed-based compositions.

### Example 4 - Mouldability

The ability to mould the exemplified compositions of Example 2 was tested using the following method.

Compositions were formed in a press-mould comprising male and female components. Upon removing one part of the mould, the adhesive properties of each composition in gel-state could be observed before drying. It was recorded how different compositions adhered to the mould in lesser or greater degrees.

During this demoulding process, it was observed that agar-based composition (Composition 7) was damaged. This shows that agar composition does not have enough tensile strength to withstand the de-moulding process.

At the end of the drying process (right hand column below), it was observed that the compositions that contained more than 40 wt% cork granules, size 0.5 mm has cracked and damaged. On the other hand, when the corks granule size decreased to 0.2 mm, up to 43% cork granules can be used.

For those compositions comprising sawdust, tealeaves or coffee grounds, good moulding properties were observed.

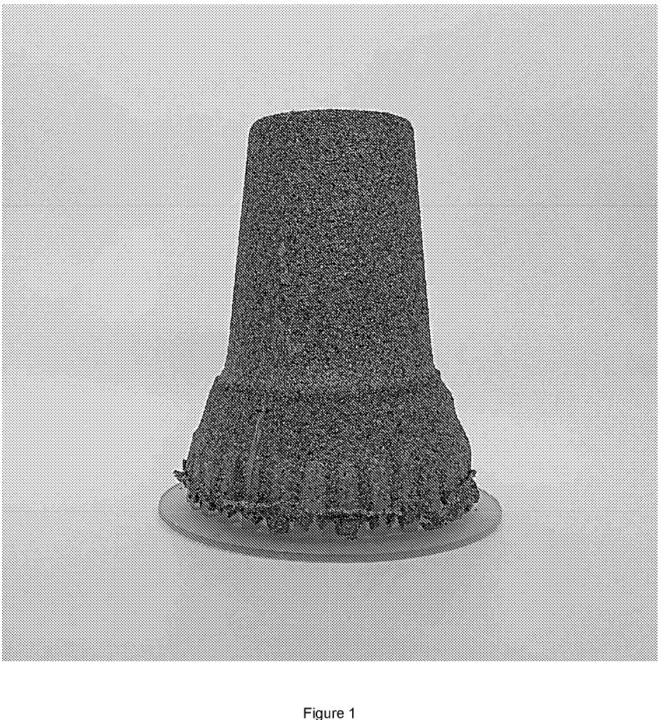

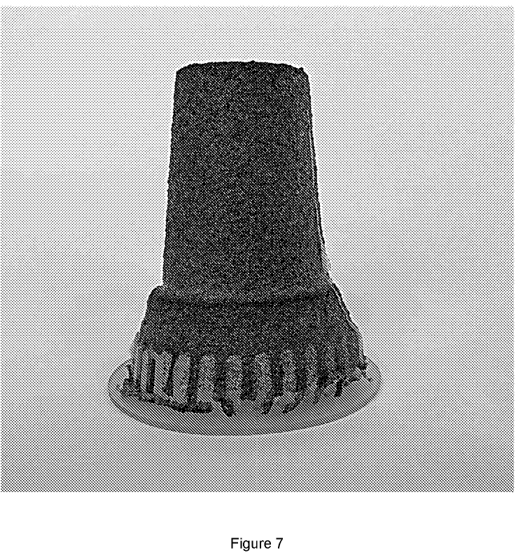

The results are shown in Table 3 and in FIGS. 1 to 8:

TABLE 3

| Composition | Mouldability Wet material | Mouldability Dry material |
|---|---|---|
| 1 | Y | Y |
| 2 | Y | N |
| 3 | Y | N |
| 4 | Y | Y |
| 5 | Y | Y |
| 6 | Y | Y |
| 7 | N | N |
| 9 | Y | Y |
| 10 | Y | Y |
| 11 | Y | Y |

Y = qualitative positive result
N = qualitative negative result

### Cork:

As seen in FIG. 1, composition 1 successfully dried on the mould without any splits or cracks.

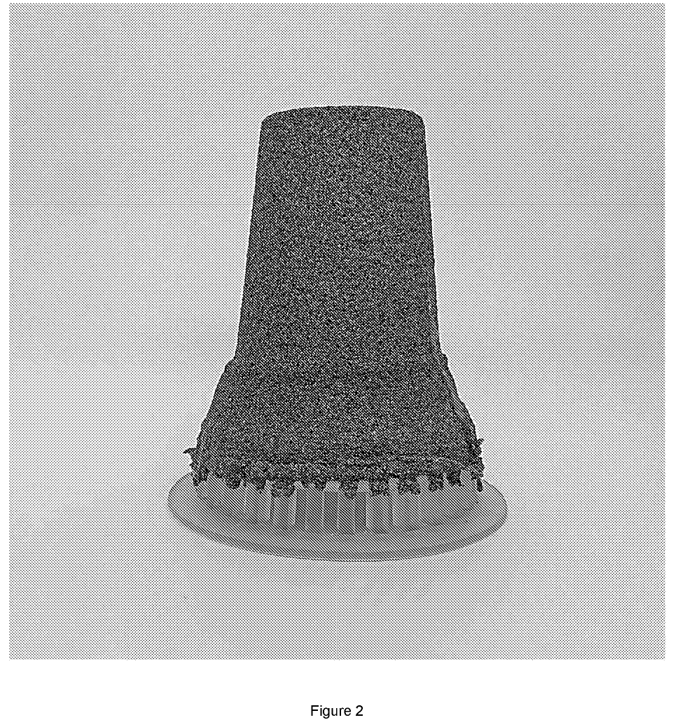

As seen in FIG. 2, composition 2 dried on the mould without any splits or cracks. However, the material shrank and escaped from the mould, causing slight deformation..

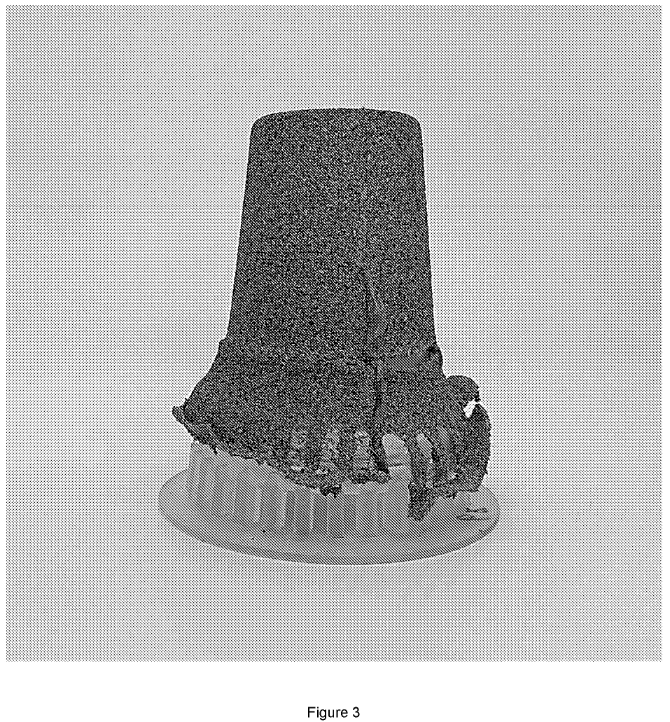

As seen in FIG. 3, composition 3 dried on the mould with a split or crack. Additionally, the material shrank and escaped from the mould, causing significant deformation.

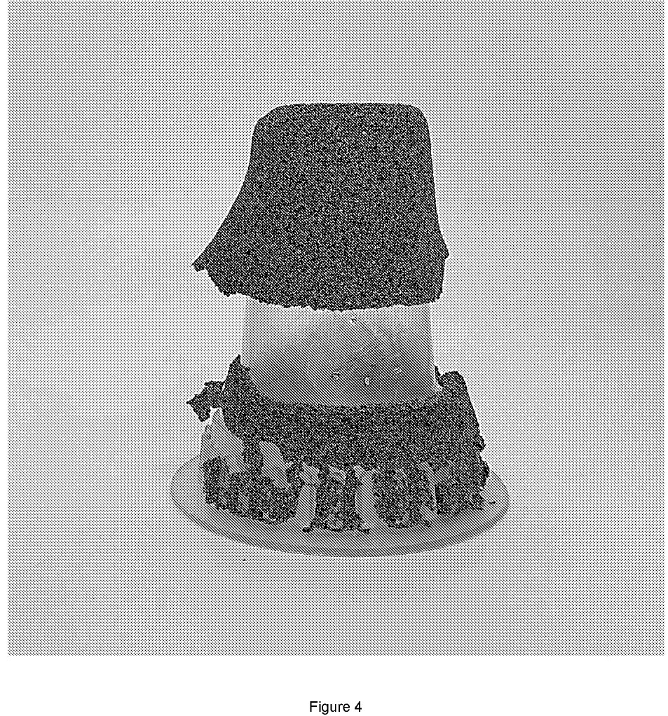

As seen in FIG. 4, composition 4 dried on the mould with several splits and cracks. Additionally, the material shrank and escaped from the mould, causing significant deformation.

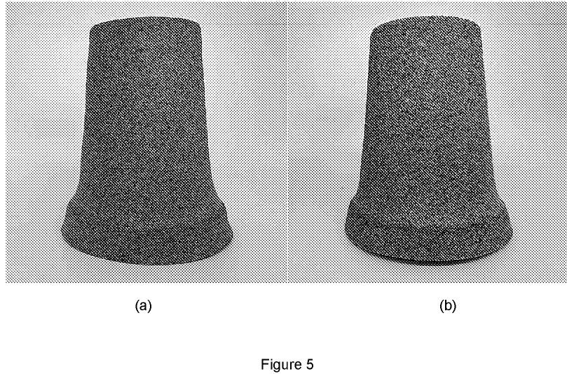

As best seen in FIG. 5, it was noted that compositions that have smaller granules have smoother and more homogenous look and feel on the surface.

### Other Biodegradable Fillers:

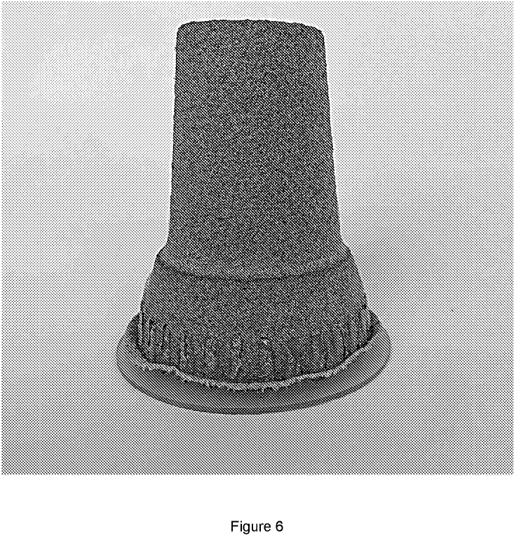

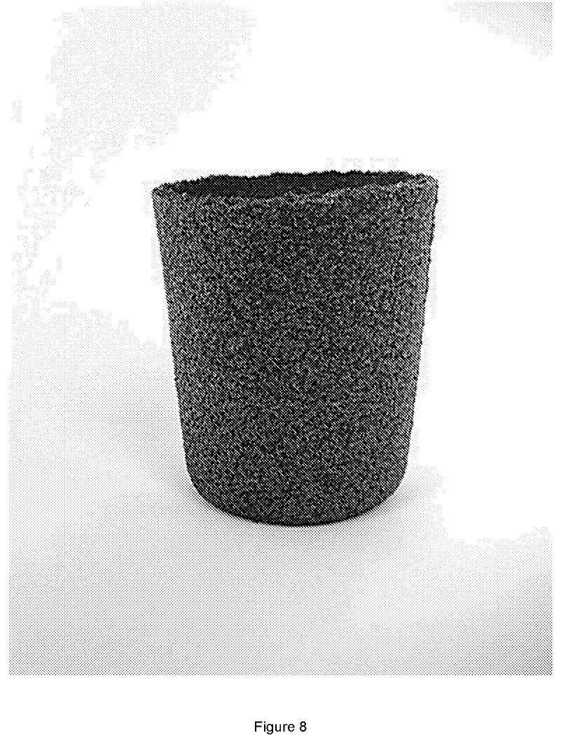

As seen in FIGS. 6 to 8, compositions 9 to 11 respectively dried on the mould without any splits or cracks. Additionally, composition 11, as shown in FIG. 8) is taken out of the mould after dried and then trimmed.

### Example 5 - Density/Lightness

Compositions 1 - 7 and 9 to 11 of Example 2 used to determine the density of the final dried compositions. As indicated by the mass of a given sample.

Each composition was poured into the same mould with the same volume. The final dry material weights and thicknesses were measured.

The results are shown in Table 4:

TABLE 4

| Composition | Dry material Weight/g | Dry material Thickness/mm |
|---|---|---|
| 1 | 12.7 | 1.5 |
| 2 | 12.5 | 1.7 |
| 3 | 12 | 2 |
| 4 | 10.7 | 0.5 |
| 5 | 10.2 | 0.7 |
| 6 | 9.8 | 1 |
| 7 | 12.3 | 1.7 |
| 8 | 9.5 | 0.3 |
| 9 | 15 | 1.8 |
| 10 | 13 | 1.7 |
| 11 | 16 | 1.7 |

When the solid gels/compositions are first de-moulded (when wet) they all have the same thickness in the same mould. After they are left to dry on the male mould, the water evaporates and the material shrinks. Therefore, the final dried thickness is determined by the water content and the particle size of the bio-filler. This also means that only the inner (hallow) volume is controlled by virtue of the male mould.

The density is measured by dividing the mass by total volume (higher thickness means higher total volume).

According to the results, the composition with the lowest density was Composition 3 which has highest cork content and the smaller cork granule size. Density is measured by mass divided by volume (M/V); therefore, Composition 3 that contains 0.5 granule size has the lowest density. However, since all the compositions were moulded into the same volume, Composition 6, that contains 0.2 granule size was the lightest but more dense than the rest of the compositions.

It can be seen from the table that cork compositions (examples 1-6) are more light weight than the other tealeaves, sawdust and coffee grounds (examples 9-11).

### Example 6 - Analysis of Carrageenan Kappa

The carrageenan kappa used in the above examples was identified as originating from the tropical plant species Eucheuma cottonii/kappaphycus alvarezii (the two are usually treated as one in industry) using a gel press process with no added diluents.

One embodiment of the carrageenan kappa used in the exemplified examples of the invention was analysed. The general comment was that the samples was a very common, gel press type kappa, good colour and excellent clarity. A general-purpose grade rather than a specific jelly, confectionery or dairy grade.

Typical properties and comments regarding the sample used are shown in Table 5:

TABLE 5

A very similar grade we have seen in the past is Andi-Johnson^{®} AJK-491.

| Test | Results and comments |
|---|---|
| Moisture | 12.6496 w/w repeat was 12.8896 w/w |
| | Appears slightly too high, spec is no more than 12%. |
| Viscosity | 91 mPa.S |
| | Low for a refined carrageenan. The spec is greater than 5 mPa.s so well within spec. but on the low side for a refined kappa. refined kappa grades can be over 200 mPa.S. |
| | A low viscosity also allows a higher concentration during filteration on the factory, which reduces processing costs slightly. |
| Salts | 2.8% as KC1, repeat was 2.5% |
| | Chloride expressed as potassium chloride. Note the cations may differ, however the gel strength of the water gel suggest the salts are mainly porassium. |
| | This is typical of a gel press grade where the kappas carrageenan is gelled with potassium salts and then squeezed to remove excess water and salts. Depending on the efficiency of the pressing operation you typically see around 1-2% residual potassium chloride in the sample. Chinese confectionery grades for use in high [image] |
| | The water gels correlates with the salt analysis assumption that the salts are all potassium chloride. The water gel is low, with no syneresis and a long break distance fora kappa. The fact there is a significant gel for the water gel tells us there is residual potassium in the product which almost certainly comes from the gel press process. |
| | The salt gel is typical for medium quality grade gel pressed carrageenan. High quality grades will typically have gel strenghts over 1000 gms and the very best can be over 1200 gms. These high gel grades are prized for Asian dessert jelly applications. A gel strength of 800 gms is at the low and of the spectrum and combined with the low viscosity and good colour suggest the grade is heavily bleached. |
| | Some grades contain calcium salts, these lend to raise the gels strength, reduce the break distance (harder, more brittle gel) and often leave a milky haze. This sample does not appear to have any residual calcium salts present. The sightly cured force-distance curve is typical of a potassium-kappa type gel. |
| Wash out solids | 11% |
| | This best measures the amount of material in the sample that is soluble in 60% IPA. It is used to determine if the sample has any soluble solids (salts, sugars) that are not picked up in the chloride titration. Due to the nature of the test it is a rough estimate and the complete mass balance of wash out solids, moisture and salt titration is usually only accurate to +/- ~546. |
| | 11% wash out solids should correlate to the moisture plus the salts {which is nearer 15%} but we have assumed all salts are potassium chloride and only salts and moistere are removed by the wash. The test tells us there is probably no added diluents. |
| Clarity | Excellent. No sign of any f or calcium induced haze. |
| | Not measured, visual. |
| Powder colour | L* = 89.39. a* = -0.46, b* = 8.31 |

Very white product, very good colour, probably heavily bleached which may also account for the low viscosity.

A typical specification for carrageenan kappa to be used in the invention are shown in Table 6:

TABLE 6

| | |
|---|---|
| Specification | Range |
| General | A refined kappa made by the gel press process using either eucheuma cottonii or kappaphycus alvarezii. |
| Moisture | Not more than 12% w/w |
| Viscosity | Greater than 60 mPa.S |
| | (This is to cut out very low viscosity grades that are sometimes used in the dairy industry, the legal spec is greater than 5 mPa.S). |
| Gel strength | Greater than 800 gms |
| | (Based on 1.2% carrageenan in 0.3% KCI at 20° C. Be careful there are many different tests used and most give a higher reading). |
| Salts | No more than 3% w/w measured as potassium chloride. |
| Powder colour | L* greater than 85 using a Minolta colour tester. |

Although particular embodiments of the invention have been disclosed herein in detail, this has been done by way of example and for the purposes of illustration only. The aforementioned embodiments are not intended to be limiting with respect to the scope of the invention. It is contemplated by the inventor that various substitutions, alterations, and modifications may be made to the invention without departing from the scope of the invention.

1. A composite material comprising a seaweed extract in an amount of 30-70 % by weight, a biodegradable filler in an amount of 20-60 % by weight and water in an amount of 1-20 % by weight of the total weight of the composite.

2. The composite material of claim 1, wherein the seaweed extract in present an amount of 40-60 % by weight, a biodegradable filler in an amount of 30-50 % by weight and water in an amount of 2-15 % by weight.

3. The composite material of claim 1 or claim 2, wherein the composite consists essentially of the seaweed extract the biodegradable filler and water.

4. The composite material of any one of claims 1 to 3, wherein the composite consists of the seaweed extract the biodegradable filler and water.

5. The composite material of any one of claims 1 to 4, wherein the weight percentages of the seaweed extract the biodegradable filler and water total 100 % by weight of the total weight of the composite.

6. The composite material of any one of claims 1 to 5, wherein the seaweed extract is selected from the group consisting of: a carrageenan; agar; alginate; and a mixture thereof.

7. The composite material of claim 6, wherein the seaweed extract is a carrageenan.

8. The composite material of claim 7, wherein the carrageenan is carrageenan kappa.

9. The composite material of any one of claims 1 to 8 wherein the composite lacks one or more of the group consisting of: a starch; carrageenan iota; agar; alginate; and chitosan.

10. The composite material of any one of claims 1 to 9, wherein the biodegradable filler is selected from the group consisting of: cork, tealeaves, coffee granules, sawdust, paper, hemp fibre, hay, straw, dried and granulated food waste, dried and granulated plant seed, dried and granulated fruit and vegetable peel or skin and mixtures thereof.

11. The composite material of claim 10, wherein the biodegradable filler is cork.

12. The composite material of any one of claims 1 to 3 and 6 to 11, wherein the composite further comprises one or more additives.

13. The composite material of claim 12, wherein the one or more additives are present in no greater than 40 % by weight of the total weight of the composite.

14. The composite material of claim 12 or claim 13, wherein the one or more additives are selected from the group consisting of: salts such as sea salt, table salt, sodium chloride, potassium chloride; and glycerol.

15. The composite material of any one of claims 1 to 14, wherein the composite is fully biodegradable.

16. The composite material of claim 15, wherein the seaweed-extract of the composite:
a) fully biodegrades in less than six months in an external, non-industrial environment;
b) fully biodegrades in an aerobic and/or anaerobic atmosphere; and/or
c) is fully compostable in less than six months in a domestic compost heap
d) fully biodegrades in ocean in less than 6 months.

17. The composite material of any one of claims 1 to 16, wherein the composite is mouldable.

18. A product formed from the composite material of any one of claims 1 to 17.

19. The product of claim 18, wherein the product has a shape selected from the group consisting of: a plate; planar sheet; a regular sphere; an irregular sphere; a regular spheroid; an irregular spheroid; a regular cube; an irregular cube; a regular cuboid; an irregular cuboid; a regular ellipsoid; an irregular ellipsoid; a regular cylinder; an irregular cylinder; a regular cone; an irregular cone; a regular prism; an irregular prism; a regular pyramid; an irregular pyramid; a shell, a clam, or a shape with an internal void or hollow, and any combination thereof.

20. A method of producing the composite material of any one of claims 1 to 17, the method comprising the steps of:
a) contacting the seaweed extract with water to form a seaweed extract hydrogel,
b) mixing the seaweed extract hydrogel and a biodegradable filler to form a mixture, and
c) allowing the mixture to dry in order to form the composite.

21. The method of claim 20, wherein step (a) comprises heating the mixture of the seaweed extract in water to a temperature in the range of approximately 70° C. to approximately 100° C. to form the seaweed extract hydrogel.

22. A method of producing a product of claim 18 or claim 19, the method comprising the steps (a) to (c) of the method of producing a composite as claimed in claim 20 or claim 21, and between steps (b) and (c) the additional step of: moulding the mixture into a shape or a three-dimensional form of the product.

23. A method of re-working a product, comprising producing a product by the method of claim 22, wherein the method further comprises:
f) softening or melting the product by contacting the product with water or steam to provide a softened product;
g) further manipulating the softened product to provide a re-worked product, wherein the re-worked product has a different shape to the product;
h) allowing the re-worked product to dry to provide a dried re-worked product.

24. A method of industrial biodegradation of the composite of any one of claims 1 to 17, or the product of claim 18 or 19, the method comprising the step of exposing the composite or product to conditions in which the rate of biodegradation is increased.

25. A method of composting the composition of any one of claims 1 to 17, or the product of claim 18 or claim 19, the method comprising the step of exposing the composition or product to conditions in which the composition or product degrades to form compost or material suitable for use in compost or as an additive to soil to be used as a soil fertiliser.
